(19) United States
(12) Patent Application Publication
(10) Pub. No.: US 2026/0228438 A1
(43) Pub. Date: Aug. 6, 2026

(54) Geometric Multi-Modal Sensor Fusion for Infrastructure Monitoring

(71) Applicant: AtomBeam Technologies Inc., Moraga, CA (US)

(72) Inventor: Brian Galvin, Silverdale, WA (US)

(21) Appl. No.: 19/352,457

(22) Filed: Oct. 7, 2025

Related U.S. Application Data
(63) Continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(63) Continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for monitoring critical infrastructure combines multiple types of sensor data, including acoustic, vibration, and video sensors, into a unified geometric framework for enhanced threat detection. The system represents sensor information as geometric structures within a curved mathematical space that preserves the timing relationships between different types of sensor events. By computing optimal paths through this geometric space, the system can reason across different sensor types to identify patterns that indicate potential threats or equipment failures. The geometric representation naturally handles data compression while maintaining the relationships between different sensor modalities. When anomalies are detected through analysis of geometric patterns and information density, the system can generate alerts and provide explanations by traversing the geometric space. This approach enables earlier, and more accurate threat detection compared to traditional systems that analyze each sensor type separately before combining results.

### CROSS-REFERENCE TO RELATED APPLICATIONS

Priority is claimed in the application data sheet to the following patents or patent applications, each of which is expressly incorporated herein by reference in its entirety:
63/847,969
U.S. Ser. No. 19/321,173
U.S. Ser. No. 19/284,115
U.S. Ser. No. 19/051,193
63/847,082
63/847,091
63/847,096
63/847,101
U.S. Ser. No. 19/038,801
U.S. Ser. No. 18/818,593
U.S. Ser. No. 18/657,719
U.S. Ser. No. 18/410,980
U.S. Ser. No. 18/537,728

### BACKGROUND OF THE INVENTION

### Field of the Invention

The present invention relates to the field of multi-modal sensor fusion and critical infrastructure monitoring, particularly to systems that combine distributed acoustic sensing, vibration sensors, and video surveillance using geometric cognitive processing for enhanced threat detection and anomaly identification.

### Discussion of the State of the Art

Critical infrastructure monitoring systems currently rely on multiple sensor types to detect threats, equipment failures, and operational anomalies. Distributed acoustic sensing (DAS) systems use fiber-optic cables to detect vibrations and acoustic signatures across long distances, providing spatially continuous monitoring of pipelines, perimeters, and transportation networks. Vibration sensors including accelerometers and seismometers capture temporal signatures of mechanical systems and structural movements. Video surveillance systems provide visual context and motion detection capabilities. These sensor modalities generate complementary information that, when properly combined, can significantly improve threat detection accuracy and reduce false alarm rates.

However, conventional approaches to multi-modal sensor fusion suffer from fundamental architectural limitations. Most existing systems process each sensor type independently using specialized algorithms optimized for that particular modality. Acoustic data is typically analyzed using signal processing techniques focused on frequency domain analysis and pattern recognition. Vibration data is processed using time-series analysis methods that identify characteristic signatures of normal and abnormal mechanical behavior. Video streams are analyzed using computer vision algorithms that detect motion, recognize objects, and track activities. Only after this separate processing are the results combined at the decision level, where voting schemes, weighted averaging, or rule-based logic determine final threat assessments.

This decision-level fusion approach creates several critical problems. First, it discards the rich temporal relationships between sensor modalities that often contain the most valuable diagnostic information. For example, an acoustic signature detected by DAS sensors may precede corresponding vibration patterns and visual confirmations by seconds or minutes, but this causal ordering is lost when sensors are processed independently. Second, the separate processing pipelines cannot leverage cross-modal correlations that could improve signal quality and reduce noise. Third, when anomalies are detected, investigators must manually correlate information across different sensor systems and analysis tools, making rapid response and forensic analysis time-consuming and error-prone.

Current fusion methods also lack the ability to adaptively focus computational resources on the most informative sensor combinations for a given scenario. Fixed processing pipelines allocate equal resources to all sensor streams regardless of their current relevance to threat detection. This leads to inefficient resource utilization and missed opportunities to enhance analysis of critical events. Additionally, most existing systems provide limited capability for multi-scale investigation, forcing operators to work with fixed temporal and spatial resolutions that may not be optimal for understanding complex events.

Privacy and security concerns further complicate traditional approaches. Centralized processing of sensitive sensor data from critical infrastructure creates attractive targets for cyberattacks and raises concerns about data privacy. Many current systems lack the ability to perform meaningful analysis on encrypted data, forcing organizations to choose between security and analytical capability.

What is needed is a system that preserves temporal causality and cross-modal correlations by fusing heterogeneous sensor data within a unified geometric framework that enables multi-scale investigation, maintains privacy through encryption-compatible processing, and adapts resource allocation based on threat-relevant information density.

### SUMMARY OF THE INVENTION

The inventor has conceived and reduced to practice a computer system that transforms critical infrastructure monitoring by unifying multiple sensor types within a single geometric cognitive framework. Rather than processing acoustic sensors, vibration detectors, and video cameras separately before combining their outputs, the invention represents all sensor data as geometric structures within a curved mathematical space that preserves the natural timing relationships between events. This geometric approach enables the system to reason across sensor modalities by computing optimal paths through the curved space, leading to earlier and more accurate detection of threats and equipment failures. The system maintains data privacy through geometric-preserving compression methods while continuously learning and adapting its internal structure based on successful detection patterns.

In an embodiment, a computer system maintains a latent manifold as a geometric substrate for cognitive operations where the manifold has a pseudo-Riemannian metric that distinguishes temporal and spatial directions to preserve causality and evolves through use. The system receives multi-modal sensor data from infrastructure monitoring systems and encodes this data into geometric structures within the latent manifold where semantic relationships between sensor modalities are represented through geometric properties including distance and curvature. The system compresses the multi-modal sensor data using methods that preserve geometric relationships and computes geodesic paths through the latent manifold for cross-modal reasoning where the paths connect related phenomena across different sensor modalities and are influenced by compression pressure derived from manifold curvature. The system stores persistent multi-modal representations as geometric regions within the latent manifold where frequently accessed sensor fusion patterns develop characteristic geometric properties, detects anomalies by identifying deviations from normal geometric patterns through compression pressure analysis and cross-modal geodesic correlation, modifies the geometric structure of the latent manifold based on cognitive operations where successful detection patterns create persistent modifications to the manifold geometry, and generates outputs by traversing the latent manifold and decoding geometric information into user-interpretable responses.

In an aspect of an embodiment, the pseudo-Riemannian metric constrains geodesic paths to preserve temporal causality by maintaining time-forward progression through the manifold.

In an aspect of an embodiment, the multi-modal sensor data includes distributed acoustic sensing data, vibration sensor data, and video surveillance data from critical infrastructure monitoring.

In an aspect of an embodiment, computing geodesic paths involves calculating trajectories that maintain causal ordering of sensor events across different modalities.

In an aspect of an embodiment, the system performs multi-scale navigation by continuously traversing the latent manifold across different levels of spatial and temporal resolution.

In an aspect of an embodiment, detecting anomalies involves identifying regions of high compression pressure that exceed predetermined thresholds indicating areas requiring detailed analysis.

In an aspect of an embodiment, the system generates alternative scenarios by modifying stored geodesic paths and computing resulting trajectory variations.

In an aspect of an embodiment, the compression methods include homomorphic encryption that enables computation on encrypted sensor data while preserving the geometric relationships in the latent manifold.

In an aspect of an embodiment, the system enhances degraded sensor data using correlation-based reconstruction that leverages learned spatiotemporal patterns from multiple sensor modalities.

In an aspect of an embodiment, the system synchronizes multi-modal sensor streams by aligning temporal sequences according to causal ordering constraints derived from the pseudo-Riemannian metric.

In an embodiment, the method aspects of the computer system disclosed above are implemented as computer-implemented methods for multi-modal sensor fusion that perform the same operations and provide the same technical advantages as the corresponding computer system embodiments.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for geometric multi-modal fusion system, including subsystems for sensor input, encoding, latent manifold processing, cognitive reasoning, secure analysis, decision-making, and multi-scale operator interaction.

FIG. 2 is a conceptual diagram illustrating temporal causality preservation in a Lorentzian latent manifold, where sensor events are embedded as time-ordered geometric structures and connected through causality-respecting geodesic paths.

FIG. 3 is a flow diagram illustrating the multi-modal data encoding and geometric transformation process, including data quality assessment, modality-specific encoding, temporal synchronization, and latent manifold embedding.

FIG. 4 is a flow diagram illustrating compression pressure calculation and geodesic path computation, including curvature analysis, cognitive action functional minimization, path validation, and manifold reinforcement.

FIG. 5 is a flow diagram illustrating multi-scale investigation and zoom capabilities, enabling operators to navigate spatial and temporal resolution levels during anomaly analysis using scale-adaptive geodesic recomputation.

FIG. 6 is a flow diagram illustrating homomorphic processing and privacy-preserving computation, including encryption key generation, encrypted geodesic computation, federated learning, and selective result decryption.

FIG. 7 is a block diagram illustrating an exemplary latent transformer architecture, including a VAE encoder, latent transformer subsystem, and decoder pipeline for latent space processing of encoded sensor data.

FIG. 8 is a flow diagram illustrating counterfactual simulation and scenario generation, including geodesic perturbation, scenario-specific trajectory evaluation, risk assessment, and operational application across training, optimization, and forensic workflows.

FIG. 9 illustrates an exemplary computing environment on which an embodiment described herein may be implemented.

### DETAILED DESCRIPTION OF THE INVENTION

The inventor has conceived and reduced to practice a computer system for multi-modal sensor fusion combines heterogeneous sensor data streams within a unified geometric cognitive framework to enable enhanced monitoring and threat detection for critical infrastructure. Rather than processing different sensor types independently and combining results at a decision level, embodiments of the system encode multi-modal sensor data into geometric structures within a latent manifold that preserves temporal causality and cross-modal relationships. This geometric approach enables cross-modal reasoning through geodesic path computation and supports multi-scale investigation capabilities that allow operators to traverse seamlessly from infrastructure-wide monitoring to component-level analysis.

Embodiments implement a latent manifold as a geometric substrate for cognitive operations, where thoughts and sensor representations exist as persistent structures with variable curvature. A pseudo-Riemannian metric governs this latent space, distinguishing temporal and spatial directions to preserve causality in sensor data relationships. In some embodiments, this metric has a signature that designates one coordinate as time-like and remaining coordinates as space-like, enforcing temporal causality constraints that ensure proper ordering of sensor events across different modalities. In certain embodiments, this metric may have the form g=diag(−1, +1, +1, . . . , +1), where the first coordinate is time-like and remaining coordinates are space-like.

Geometric cognition operates through attention flows along geodesic paths that minimize cognitive action through curved semantic space. These paths represent optimal reasoning trajectories that connect related phenomena across different sensor modalities while preserving temporal causality. Thought bundles form coherent submanifolds representing related concepts with internal geometric structure, enabling hierarchical organization of sensor fusion patterns.

Compression pressure derived from manifold curvature creates cognitive cost in semantically dense regions and serves as an information density indicator for threat prioritization. Areas of high compression pressure indicate regions requiring enhanced analysis or representing critical information. A manifold geometry evolves through use, with frequently accessed sensor fusion patterns developing characteristic geometric properties that facilitate future threat detection. In some embodiments, compression pressure may be calculated as P(x)=−R(x), where R(x) represents the Ricci curvature at point x in the manifold.

The cognitive action functional that governs geodesic path selection may be defined as S[γ]=∫[t₀ to t₁] [½g(\dot{γ}(t), \dot{γ}(t))+P(γ(t))+V(γ(t))] dt, where \dot{γ}(t) represents the velocity vector along the path, g(\dot{γ}(t), \dot{γ}(t)) is the kinetic energy term computed using the pseudo-Riemannian metric, P(γ(t)) represents the compression pressure penalty derived from local manifold curvature, and V(γ(t)) is the goal potential field that attracts attention toward task-relevant regions. The integration bounds t₀ and t₁ correspond to the temporal start and end points of the reasoning trajectory, with the constraint that t₁>t₀ to maintain temporal causality. Geodesic paths are computed by minimizing this action functional subject to the constraint that γ(t) remains within the time-like cone defined by the Lorentzian metric signature, ensuring that all reasoning trajectories preserve causal ordering of sensor events.

A multi-modal sensor input layer collects and preprocesses heterogeneous sensor data for manifold embedding. Distributed acoustic sensing arrays provide fiber-optic acoustic monitoring with spatially distributed data across infrastructure perimeters, pipelines, and facilities. Vibration sensor networks comprising accelerometers and seismometers generate temporal vibration signatures that characterize mechanical system behavior and structural movements. Video surveillance systems include multi-camera arrays providing visual context, motion detection, and scene analysis capabilities. Environmental sensor arrays may monitor temperature, pressure, electromagnetic fields, and other ambient conditions. Geospatial positioning systems enable GPS and location-aware sensor coordination across distributed infrastructure.

A multi-modal encoding engine transforms heterogeneous sensor data into geometric structures within a latent manifold. Modality-specific encoders apply specialized transformation algorithms tailored to each sensor type while preserving essential characteristics of original signals. A temporal synchronization processor aligns multi-modal data streams in a time domain, with some embodiments implementing causal synchronization that uses geodesic-based alignment to ensure proper acoustic-to-vibration-to-visual causality preservation.

In some embodiments, the multi-modal encoding engine and the extended PCM latent hyperspace may operate in conjunction with a latent processing architecture. The architecture may include a VAE encoder subsystem that encodes incoming multi-modal sensor data into compact latent space representations, preserving spatial, temporal, and semantic features across sensor modalities. These latent vectors may optionally be expanded by an expander to a suitable dimensionality for processing by a latent transformer subsystem, which applies multi-head attention or similar mechanisms to extract patterns and relationships from the fused sensor data. The output of the transformer subsystem may optionally be compressed by a compressor prior to decoding by a VAE decoder subsystem. The decoder reconstructs higher-level sensor features or predictive signals from latent space. In some implementations, the compressed generated output may be used to generate alerts, drive anomaly detection workflows, or update memory structures within a PCM latent manifold. This latent transformer architecture provides one possible implementation of the manifold-based processing and geometric encoding operations described throughout the system.

The multi-modal sensor integration process accommodates heterogeneous data acquisition systems through standardized interface protocols that normalize temporal sampling rates, spatial coordinate systems, and signal amplitude scales before geometric embedding. Distributed acoustic sensing arrays typically operate at 1-10 kHz sampling rates with spatial resolution of 1-10 meters along fiber-optic cables, while vibration sensors provide 100-1000 Hz temporal resolution with sub-millimeter displacement sensitivity, and video surveillance systems generate 15-60 frames per second with pixel-level spatial resolution. The temporal synchronization processor implements adaptive buffering mechanisms that accommodate these varying data rates while maintaining causality constraints, using interpolation and decimation techniques to align sensor streams within a common temporal framework. Calibration procedures establish baseline geometric relationships by monitoring normal operational patterns for 24-168 hours, during which the system learns the characteristic manifold structure for each sensor modality and discovers the optimal hyperspace dimensionality required to preserve cross-modal correlations without excessive computational overhead.

The integration between the VAE encoder subsystem and the geometric manifold operations occurs through a dimensional bridging process where the compact latent vectors produced by the VAE encoder are mapped into the high-dimensional hyperspace through a learned embedding function that preserves both the semantic content extracted by the encoder and the geometric relationships required for manifold operations. In some embodiments, this mapping process includes a geometric consistency loss term that ensures the embedded vectors maintain the distance relationships and clustering properties discovered during VAE training while adapting to the curved geometry of the latent manifold. The manifold discovery process operates on these embedded representations by identifying regions of high data density and semantic coherence, using spectral analysis of the local geometry to determine the intrinsic dimensionality of the effective manifold within the hyperspace. This discovered manifold structure then constrains subsequent geodesic computations and attention flow operations, creating a learned geometric substrate that captures the essential sensor fusion patterns while maintaining computational efficiency.

Spatial correlation engines map geographic relationships into manifold topology, enabling representation of distributed sensor networks within unified geometric space. Semantic feature extractors identify meaningful patterns within each modality, while cross-modal binding generators create association markers between related sensor events with temporal causality constraints. This encoding process results in causally-ordered geometric structures where semantic relationships between sensor modalities are represented through geometric properties including distance and curvature.

An extended latent hyperspace serves as a high-dimensional geometric substrate supporting multi-modal thought representation and fusion, where incoming sensor data from distributed acoustic sensing arrays, vibration sensor networks, and video surveillance systems is initially embedded into an ambient space of sufficient dimensionality to preserve complex cross-modal relationships and temporal dependencies. Within this hyperspace, the enhanced cognitive dynamics engine discovers and maintains a lower-dimensional manifold that captures the essential geometric structure of effective sensor fusion patterns while providing computational efficiency for geodesic path computation and attention flow operations. This learned manifold includes specialized regions optimized for different sensor modalities, with dedicated subspaces that preserve the unique characteristics of acoustic signatures, vibrational patterns, and visual features, along with fusion zones where cross-modal integration occurs through geodesic trajectories that respect temporal causality constraints. The hierarchical hyperspace-manifold architecture enables the system to maintain representational flexibility for novel sensor combinations and evolving threat patterns while concentrating computational resources on the lower-dimensional manifold where semantic relationships between sensor modalities are encoded through geometric properties including distance, curvature, and compression pressure fields that guide cognitive attention and anomaly detection processes.

Cross-modal thought bundles form coherent submanifolds representing fused sensor concepts with hierarchical organization supporting multi-scale investigation. Causal geodesic constraints ensure that sensor fusion paths preserve temporal causality and information flow direction. Multi-scale compression fields encode relationships between sensor types across different resolution levels, from infrastructure-wide patterns down to individual component behaviors.

Temporal coherence structures maintain geometric preservation of time-dependent relationships across sensor modalities. Compression pressure saliency fields create information density gradients that indicate threat-relevant regions requiring prioritized analysis. Attention vector fields provide dynamic flow guidance for cognitive focus across modalities with causal awareness of event progression.

An enhanced cognitive dynamics engine manages geometric operations and manifold evolution for multi-modal processing. A geometry manager maintains manifold structure across heterogeneous data types while preserving time-like constraints and causal relationships. Multi-scale zoom controllers enable continuous traversal across spatial, temporal, and semantic scales, allowing investigation to progress from network-wide anomaly detection to component-level diagnostic analysis.

Curvature computers calculate compression pressure considering all modality interactions and temporal causality relationships. This computation identifies regions of high information density that may indicate emerging threats or equipment anomalies. Fusion trajectory solvers compute optimal causal paths through multi-modal manifold regions, determining geodesic routes that connect related phenomena across different sensor types while maintaining proper temporal ordering.

Modal attention flow computers distribute cognitive attention across sensor domains using causal priority weighting that reflects event progression timing. Anomaly detection processors identify deviations from normal geometric patterns through compression pressure analysis and cross-modal geodesic correlation. When anomalies exceed predetermined thresholds, systems generate alerts and direct enhanced analysis resources to affected regions.

Causal inference engines track cause-effect relationships through geodesic analysis with temporal constraints, enabling systems to understand event progression across sensor modalities. Counterfactual simulation engines generate alternative scenarios by applying controlled perturbations to stored geodesic paths and computing resulting trajectory variations. This capability supports “what-if” analysis for threat response planning and incident reconstruction. The length of such geodesic paths may be computed as L[γ]=∫√(−g(\dot{γ}(t), \dot{γ}(t))) dt, ensuring time-like trajectory constraints are maintained.

When temporal causality constraints are violated due to sensor failures, network delays, or asynchronous data arrival, the system implements adaptive recovery mechanisms that maintain operational continuity while preserving geometric integrity. Causality violation detection occurs through monitoring of the pseudo-Riemannian metric constraints, where sensor events that arrive outside their expected temporal ordering trigger recalibration procedures that adjust timing offsets and recompute geodesic paths using relaxed temporal windows. In cases where sensor dropout occurs, the system dynamically reconfigures the manifold geometry by adjusting the compression pressure fields to compensate for missing modalities, increasing sensitivity in remaining sensor domains while maintaining statistical confidence bounds for detection decisions. When geodesic computation fails due to manifold discontinuities or excessive curvature, fallback reasoning mechanisms revert to local geometric analysis within stable manifold regions, providing degraded but functional threat assessment capabilities until full geometric coherence can be restored through manifold healing processes that gradually reconnect disrupted regions using correlation-based interpolation.

A secure multi-modal processing layer enables privacy-preserving computation while maintaining geometric relationships essential for effective sensor fusion. Homomorphic fusion processors perform computations on encrypted multi-modal data, allowing analysis without exposing sensitive sensor information. This encryption-compatible processing preserves geometric relationships within latent manifolds while protecting critical infrastructure data.

Correlation-based enhancement engines provide temporal correlation upsampling for degraded video and sensor data using learned spatiotemporal priors. These systems leverage cross-modal dependencies to restore information lost during compression or transmission, improving overall sensor data quality without compromising privacy protection.

Bandwidth optimization controllers implement compression pressure-guided adaptive allocation, dynamically adjusting data transmission and processing resources based on threat level assessment and network capacity constraints. Privacy-preserving transmission maintains geometric relationships while encrypting sensor data with causal structure preservation. Federated learning coordinators enable knowledge sharing across distributed infrastructure sites while preserving local privacy and maintaining temporal causality in shared information.

A fusion analysis and decision engine extracts actionable intelligence from multi-modal geometric analysis. Threat pattern recognition systems identify security threats through cross-modal correlation with causal validation, ensuring that detected patterns reflect genuine threat progression rather than coincidental sensor activations. Multi-scale threat investigation capabilities provide continuous zoom functionality, enabling operators to traverse from network alerts to component-level analysis via geodesic navigation.

Infrastructure health diagnostic systems detect structural anomalies using fused sensor analysis across multiple temporal and spatial scales. Event classification systems categorize incidents based on multi-modal signature fusion with temporal causality verification, ensuring proper understanding of event progression. Visual narrative reconstruction engines extract causal event sequences from fused geodesics, supporting detailed incident analysis and forensic investigation.

Temporal anomaly zooming capabilities enable slow-motion analysis of critical threat windows using geometric time dilation effects within latent space. Predictive analytics engines forecast events using geometric trajectory analysis with causal constraints, projecting likely future developments based on current sensor fusion patterns.

Risk assessment calculators quantify threat levels using manifold distance metrics and compression pressure indicators. Response priority ranking systems order alerts based on geometric urgency indicators and causal threat propagation patterns. False positive suppression filters eliminate spurious alerts through cross-modal validation and temporal coherence checks. Confidence estimation engines assess reliability of fusion-based conclusions using geodesic path confidence metrics derived from manifold geometry.

A multi-scale cognitive navigation engine enables continuous traversal across infrastructure monitoring scales and temporal dimensions. Spatial zoom controllers support navigation from network-level to facility-level to component-level to individual sensor resolution via geometric scale transitions. Temporal zoom controllers enable traversal across real-time, historical, and predictive time scales using geometric time parameterization within latent space.

Threat investigation pathways provide guided geodesic traversal for systematic incident analysis across modalities. Cross-modal resolution scaling adapts detail levels based on threat severity and compression pressure indicators, automatically allocating enhanced resolution to critical analysis regions. Cognitive saliency mapping creates compression pressure visualization for operator attention guidance, highlighting areas requiring focused investigation.

Causal path visualization displays cause-effect relationships through geodesic flow patterns, enabling operators to understand event progression across sensor modalities. Scale-adaptive memory access retrieves stored patterns at appropriate resolution levels for current investigation context. Multi-dimensional zoom coordination synchronizes scaling across spatial, temporal, and semantic dimensions during analysis operations.

Output and response interfaces present analysis results and enable human-system interaction through multiple modalities. Real-time alert generators provide immediate notifications based on manifold anomaly detection with multi-scale context information. Interactive zoom interfaces enable human operators to traverse multi-scale threat analysis via geodesic navigation, providing intuitive exploration of complex sensor fusion results.

Geometric visualization dashboards display manifold state and sensor fusion results with compression pressure mapping, enabling operators to visualize information density and threat progression patterns. Causal event timelines present incident reconstruction with preserved temporal causality, showing proper ordering of events across sensor modalities.

Counterfactual scenario visualizers provide “what-if” threat simulation displays using geodesic perturbation analysis, supporting response planning and training applications. Forensic analysis interfaces offer detailed multi-modal event reconstruction capabilities with zoom traversal functionality for comprehensive incident investigation.

Automated response controllers trigger appropriate responses based on classified events with causal validation, ensuring that automated systems respond to genuine threat progressions. Audit trail recorders maintain detection reasoning paths for accountability with geodesic path preservation, enabling post-incident analysis of system decision-making processes. Performance metrics trackers monitor system effectiveness and manifold health across multiple scales and operational conditions.

This geometric approach to multi-modal sensor fusion provides several technical advantages over conventional decision-level fusion systems. Temporal causality preservation ensures that natural progression of events across sensor modalities is maintained throughout analysis, enabling more accurate threat detection and reduced false positive rates. Multi-scale investigation capabilities allow seamless traversal from infrastructure-wide monitoring to component-specific analysis within a unified framework, improving operational efficiency and response times.

Cross-modal geodesic reasoning enables optimal path computation that leverages relationships between different sensor types, improving detection accuracy through correlation analysis that would be impossible with independent sensor processing. Compression pressure-guided resource allocation automatically focuses computational resources on most threat-relevant information, improving system efficiency and response capability.

Privacy-preserving geometric processing enables meaningful analysis of encrypted sensor data without compromising security, addressing critical concerns in infrastructure monitoring applications. Counterfactual simulation capabilities support enhanced training, response planning, and forensic analysis through geometric perturbation analysis of stored threat patterns.

The geometric approach to multi-modal sensor fusion demonstrates computational scalability advantages through hierarchical processing that concentrates expensive operations on the learned manifold while distributing routine sensor encoding across parallel processing units. In some embodiments, the system achieves real-time performance for infrastructure monitoring by maintaining manifold dimensions between 32 and 128, enabling geodesic computations to complete within 10-100 milliseconds for typical sensor correlation tasks. Memory requirements scale logarithmically with the number of stored sensor fusion patterns due to the geometric compression achieved through thought bundle formation, where semantically similar patterns converge to shared manifold regions rather than requiring independent storage. The system handles sensor networks with 100 to 10,000 distributed nodes by partitioning the hyperspace into regional subspaces that operate semi-independently while maintaining global coherence through periodic geometric synchronization operations that align local manifold structures and propagate critical threat patterns across the distributed infrastructure monitoring network.

In operation, a multi-modal sensor fusion system continuously receives heterogeneous sensor data streams from distributed acoustic sensing arrays, vibration sensor networks, and video surveillance systems monitoring critical infrastructure. Multi-modal encoding engines transform this incoming sensor data into causally-ordered geometric structures within a Lorentzian latent manifold, preserving temporal relationships while applying compression methods that maintain geometric relationships and enable privacy-preserving analysis. Cognitive dynamics engines compute geodesic paths through this latent manifold to perform cross-modal reasoning, identifying optimal trajectories that connect related phenomena across different sensor modalities while maintaining proper temporal causality. As these geodesic computations proceed, compression pressure analysis identifies regions of high information density that may indicate emerging threats or equipment anomalies, triggering enhanced analysis and multi-scale investigation capabilities that enable operators to zoom from infrastructure-wide monitoring down to component-level diagnostics. When anomalies are detected through geometric pattern analysis and cross-modal correlation, threat assessment engines generate prioritized alerts with causal event timelines, while counterfactual simulation capabilities provide “what-if” scenario analysis for response planning. Throughout this process, geometric structures within the latent manifold evolve based on successful detection patterns, creating persistent modifications that improve future threat recognition, while audit systems maintain complete reasoning paths for accountability and forensic analysis of infrastructure monitoring decisions.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “thought cache” refers to a structured memory layer configured to store and retrieve thoughts based on semantic similarity, contextual alignment, or system policy. The cache may include multiple tiers, such as session caches for short-term interaction, long-term caches for persistent knowledge, and shared or federated caches across devices or agents. Cached thoughts are indexed in latent space and may be retrieved using vector similarity, trajectory proximity, or geodesic alignment. Cached thoughts may be compressed or abstracted over time to reduce redundancy and support scalable reuse.

As used herein, “generalization” refers to the process of synthesizing a new thought from one or more cached thoughts by identifying shared structure, meaning, or trajectory. Generalized thoughts replace specific exemplars with compressed representations that maintain core semantic content while enabling reuse across a wider range of prompts or tasks. Generalization may occur explicitly during reasoning or asynchronously during background curation or dreaming.

As used herein, “latent manifold” refers to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “reinstantiation” refers to the act of reconstructing a prior thought trajectory within the current latent manifold geometry. Due to compression or manifold deformation, original paths may no longer exist in exact form; reinstantiation generates an approximate or adapted version guided by curvature, cached data, and intent fields. Reinstantiation supports memory recall, simulation, and introspective review in systems with dynamic cognitive substrates.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “typed latent entity” refers to a thought or substructure in the manifold labeled with a semantic or functional type, such as but not limited to fact, opinion, concept, trajectory, affect, cluster, or anchor. Typed entities impose constraints on valid operations such as recombination, interpolation, or pruning. Type-aware computation supports lawful memory manipulation, structured reasoning, and generalization without semantic distortion.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “latent recombinator” refers to a functional component or method configured to merge or blend similar thoughts, trajectories, or bundles in the latent manifold to form new abstractions. The recombinator may use geometric proximity, semantic alignment, or reuse statistics to determine legal recombinations, subject to type constraints and curvature continuity. It serves as a key mechanism for memory scaling, abstraction, and thought generation.

As used herein, “structured memory” refers to a persistent, geometry-aware memory architecture in which thoughts are stored not as flat vectors but as positions or paths within an evolving manifold. Structured memory supports context-sensitive access, memory reinforcement through traversal, lawful pruning, and dynamic generalization. It provides a substrate for long-term cognition, introspection, and identity continuity in systems with persistent reasoning capability.

As used herein, “Lorentzian autoencoder” refers to a neural architecture designed to encode spatiotemporal or perceptual input—such as video—into a latent manifold with Lorentzian signature, where one or more dimensions represent time-like directions. The latent structure supports temporally coherent geodesics, semantic compression, and causal continuity. Lorentzian autoencoders enable operations such as zooming, projection, and visual memory traversal.

As used herein, “multi-modal sensor fusion” refers to the process of combining heterogeneous sensor data streams from different sensing modalities to create a unified representation that preserves cross-modal relationships and temporal dependencies. In the context of infrastructure monitoring, this includes integration of distributed acoustic sensing, vibration measurements, video surveillance, and environmental sensors within a geometric framework that maintains causal ordering and enables cross-modal reasoning for enhanced threat detection and anomaly identification.

As used herein, “distributed acoustic sensing” or “DAS” refers to a fiber-optic sensing technology that uses laser interferometry to detect acoustic vibrations and strain changes along the length of an optical fiber cable. DAS systems provide spatially continuous monitoring capabilities with meter-level resolution over distances of several kilometers, enabling detection of mechanical disturbances, acoustic signatures, and environmental changes across critical infrastructure perimeters, pipelines, and transportation networks.

As used herein, “cross-modal reasoning” refers to cognitive processes that leverage relationships and correlations between different sensor modalities to derive insights that would not be apparent from analyzing individual sensor streams independently. Cross-modal reasoning operates through geodesic path computation within the latent manifold, connecting related phenomena across acoustic, vibrational, and visual domains while preserving temporal causality and semantic relationships.

As used herein, “temporal causality” refers to the preservation of cause-and-effect relationships in time-ordered sequences of events, ensuring that earlier events can influence later events but not vice versa. In the context of multi-modal sensor fusion, temporal causality constraints ensure that acoustic disturbances precede corresponding vibrations and visual confirmations, reflecting the physical progression of threats or anomalies through infrastructure systems.

As used herein, “pseudo-Riemannian metric” refers to a mathematical structure that defines distance and angle measurements on a manifold, where the metric tensor has both positive and negative eigenvalues. In embodiments using Lorentzian signatures, the metric distinguishes time-like directions from space-like directions, enabling the geometric framework to preserve temporal causality while supporting spatial reasoning across sensor modalities.

As used herein, “infrastructure monitoring” refers to the systematic observation and analysis of critical infrastructure systems including power grids, transportation networks, pipelines, telecommunications facilities, and industrial complexes to detect operational anomalies, security threats, equipment failures, and environmental hazards. Infrastructure monitoring typically employs multiple sensor types distributed across large geographic areas to provide comprehensive situational awareness and early warning capabilities.

As used herein, “counterfactual simulation” refers to the computational generation of alternative scenario outcomes by systematically modifying stored event patterns and computing the resulting trajectory variations within the latent manifold. Counterfactual simulation enables “what-if” analysis for threat response planning, forensic incident reconstruction, and training applications by exploring how different sensor configurations, timing variations, or response strategies would affect detection and mitigation outcomes.

As used herein, “multi-scale investigation” refers to the ability to continuously traverse different levels of spatial, temporal, and semantic resolution within a unified analytical framework. Multi-scale investigation enables operators to zoom from infrastructure-wide monitoring to component-level diagnostics, from real-time analysis to historical patterns, and from high-level threat assessment to detailed forensic examination through geodesic navigation within the latent manifold.

As used herein, “geometric embedding” refers to the transformation of multi-modal sensor data into geometric structures within a high-dimensional latent hyperspace, where semantic relationships between sensor modalities are preserved through spatial proximity, manifold curvature, and geodesic connectivity. Geometric embedding enables sensor fusion operations to be performed through mathematical operations on the embedded representations while maintaining the essential characteristics and temporal relationships of the original sensor signals.

### Foundational Conceptual Architecture

The present application is a continuation-in-part of U.S. patent application Ser. Nos. 19/321,173 and 18/818,593, which are hereby incorporated by reference in their entirety. The following provides a technical summary of the foundational architecture described in that application to facilitate understanding by a person of ordinary skill in the art. That foundational disclosure describes a Persistent Cognitive Machine (PCM) that fundamentally reimagines artificial intelligence through geometric representation of thought within a dynamic latent manifold. Unlike traditional AI systems that operate on flat vector spaces with stateless processing, the PCM embodies cognition as structured motion through a curved geometric substrate in which thoughts exist as persistent structures that evolve through use.

The central innovation of the PCM lies in representing thoughts—defined as discrete units of reasoning or analysis—not as static embeddings, but as geometric structures embedded within a latent manifold that evolves over time. This manifold is governed by a time-varying Riemannian metric, which defines how distances are measured locally and adapts dynamically in response to patterns of cognitive activity. As the system processes information, the manifold's curvature changes: regions corresponding to frequently accessed or semantically dense concepts develop distinct geometric properties, such as increased curvature or tighter local structure. This creates a living cognitive substrate in which memory is not stored in isolated locations but shaped continuously through the act of thinking itself.

Cognitive processing within the PCM occurs through a mechanism referred to as geodesic attention, in which focus and inference are governed not by discrete selection among options but by computing optimal paths through the manifold that minimize a defined cognitive cost. These paths, or trajectories of attention, are selected by minimizing a quantity known as the cognitive action functional—a time-integrated measure that accounts for three factors: the kinetic energy associated with moving through the manifold (reflecting the effort of shifting attention), a compression pressure that imposes a penalty for traversing semantically dense regions, and a goal potential that exerts attractive forces toward task-relevant areas of the manifold. The compression pressure field itself is derived from the manifold's intrinsic geometric properties—in particular, its scalar curvature—such that regions of high curvature, which correspond to tightly compressed or conceptually saturated knowledge, are more costly to traverse. This framework allows the system to allocate attention in a manner that is both energy-efficient and semantically purposeful.

An attention vector field, which varies across both space and time, governs how cognitive focus flows through the manifold. This field evolves according to a differential equation that balances three components: the current rate of change of attention, the influence of its own momentum, and the combined effect of compression pressure and goal potential. The result is that attention behaves like a fluid, flowing continuously through the shaped cognitive space. Its movement is guided both by memory structure—represented by regions of high compression—and by goal-directed influences that pull attention toward relevant semantic regions. This approach reframes attention not as a static weighting of inputs, but as a purposeful traversal through a dynamic geometric landscape.

To support this process, a cognitive dynamics engine operates as the system's geometric substrate processor, playing a role similar to that of a physics engine in a simulation. It is responsible for maintaining and updating the shape of the manifold in response to ongoing cognitive activity. This includes computing curvature tensors that describe the local geometric structure, updating the metric that defines spatial relationships, and solving path equations that determine how attention should move through the space. These path equations incorporate terms that capture both the underlying geometry of the manifold and external influences such as memory pressure and goal-directed forces. The engine also coordinates structural modifications to the manifold over time, ensuring that the geometry evolves to reflect patterns of use, learning, and reasoning.

Thoughts organize into thought bundles, which are localized compressible regions of manifold containing structurally similar or semantically aligned concepts that function as coherent submanifolds with their own internal geometry. These bundles support three fundamental operations: fanning-in where peripheral concepts are drawn into existing bundles through repeated co-activation, fanning-out where bundles expand into new semantic territories, and rebinding where multiple bundles merge into higher-order abstractions when sufficient semantic overlap is detected.

The system applies a thermodynamically inspired approach to memory management, where each stored thought is associated with an activation energy that decreases over time in proportion to its inactivity. The rate of decay is governed by a constant and a time-varying inactivity factor that reflects how long the thought has remained unused. When the activation energy of a thought drops below a defined threshold, the system automatically prunes it from memory. This selective forgetting mechanism helps maintain long-term efficiency by preserving frequently accessed concepts while removing obsolete or unused information.

During periods when the system is not actively engaged in processing external input, a dedicated dream manager initiates autonomous reorganization of the manifold. This process involves three coordinated mechanisms. The first is perturbation, which introduces controlled random variations to existing thoughts based on local geometric characteristics. This helps assess the stability of structures and explore nearby semantic regions. The second is recombination, where new abstract concepts are synthesized by interpolating between perturbed thoughts. The contribution of each component is weighted according to its semantic similarity and prior co-activation patterns. The third mechanism is topological surgery, which alters the global structure of the manifold by connecting previously unrelated regions or removing outdated links. These reorganizations improve the overall coherence and navigability of the cognitive substrate.

Goal management within the PCM translates abstract objectives into geometric influences by generating scalar potential fields across the manifold. These fields attract attention toward regions that are semantically relevant to the current task or intention. The directional gradient of each goal field defines a force that shapes how attention flows through the cognitive space. When combined with the effects of compression pressure, these goal-driven forces produce complex energy landscapes that guide reasoning toward desired outcomes while also respecting the structure of existing knowledge.

Persistent memory management oversees the long-term storage and retrieval of thoughts as geometric entities. It preserves not only the content of each thought, but also its full spatial context within the manifold. This includes information about local curvature, connections to other thoughts along geodesic paths, and relationships that define the topological layout of memory. The system also supports distributed cognition by coordinating memory across multiple PCM instances. It does so through geometric abstraction protocols that allow shared knowledge to be communicated while protecting private or instance-specific information. This is accomplished by projecting only select portions of thought bundles and aligning shared memory through curvature-aware transformations.

The architecture achieves efficient scaling by employing progressive compression techniques. As new information is acquired, it is often assimilated into existing geometric structures, reducing the need for additional memory. This approach enables the system to grow in capability over time while maintaining nearly logarithmic growth in storage requirements. The PCM also supports multimodal reasoning by embedding inputs from various sensory modalities —such as text, images, sound, and sensor data—into a common geometric space. Each modality is encoded with appropriate structural constraints, allowing the system to reason fluidly across different types of information within a unified framework. By grounding cognition in the geometry of evolving thought structures, the PCM offers a fundamentally different model of artificial intelligence—one that adapts with use, reasons through structure, and remembers through the spatial form of its accumulated knowledge.

### Latent Manifold Architecture for Cross-Modal Reasoning Over Acoustic, Vibration, and Visual Data

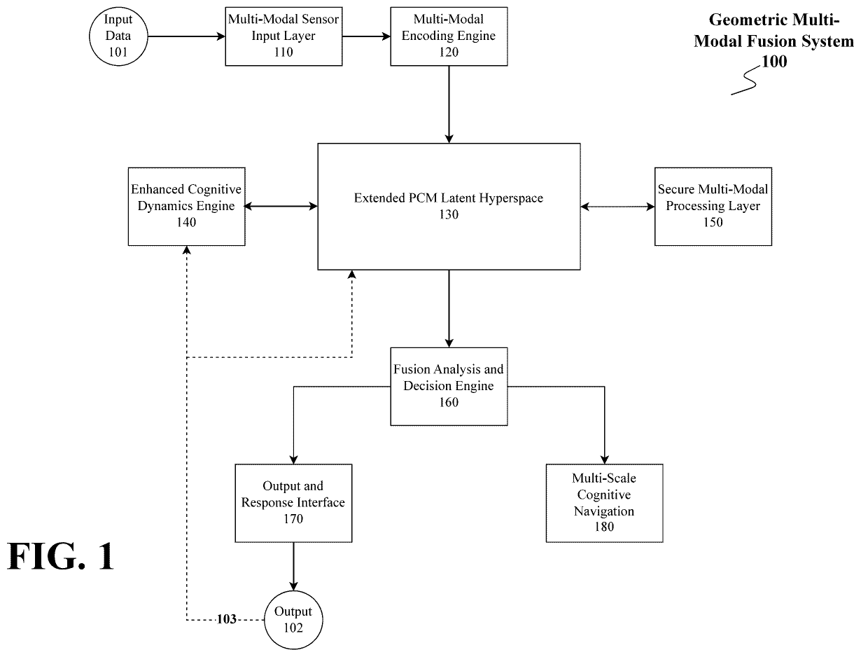

FIG. 1 is a block diagram illustrating an exemplary architecture of a geometric multi-modal fusion system for latent manifold cognition 100, in an embodiment. The system is configured to receive heterogeneous sensor data from infrastructure environments and transform that data into structured geometric representations for cognitive analysis. In some embodiments, system 100 operates as an instantiation of a Persistent Cognitive Machine (PCM), as described in U.S. patent application Ser. No. 19/321,173. The PCM framework defines a geometric cognition system in which information is represented within a dynamically evolving latent manifold. Reasoning occurs via geodesic attention flows across curved semantic structures, and memory is implemented through persistent geometric configurations known as thought bundles. System 100 extends this framework by applying PCM principles to multi-modal sensor fusion, enabling cross-modal embedding, temporal alignment, causal inference, and anomaly detection within a unified latent manifold space. Unlike prior PCM implementations involving natural language models or symbolic reasoning workflows, the present embodiment applies latent geometric cognition directly to real-time sensor data streams, integrating distributed acoustic sensing, vibration measurements, and video surveillance information for infrastructure-level decision-making.

A multi-modal sensor input layer 110 receives sensor data streams from sources that may include distributed acoustic sensing arrays, vibration sensor networks, video surveillance systems, environmental monitoring systems, and geospatial positioning sensors. Each modality provides temporally and spatially distributed signals that capture distinct aspects of operational state and environmental conditions.

A multi-modal encoding engine 120 processes these heterogeneous sensor inputs into a unified representation suitable for embedding within a latent manifold. In some embodiments, the encoding engine includes a Lorentzian encoder that applies pseudo-Riemannian metric constraints to ensure that temporal causality among sensor events is preserved during geometric transformation. For example, a causal synchronization processor may align acoustic, vibrational, and visual data streams according to their chronological progression, such that the temporal sequence of cause and effect across modalities remains intact. Cross-modal binding generators may be used to establish geometric associations between related sensor phenomena while maintaining causality constraints.

An extended PCM latent hyperspace 130 serves as a geometric substrate for multi-modal representation and reasoning. In an embodiment, the hyperspace comprises a dynamic manifold governed by a pseudo-Riemannian metric, with distinct subregions corresponding to different sensor modalities and cross-modal integration zones. Within this latent space, sensor representations are organized as persistent geometric structures known as thought bundles, which encode semantically and temporally aligned concepts. Geodesic paths may traverse these bundles to connect related sensor events across modalities, with curvature characteristics influenced by the information density and temporal structure of the underlying data.

The extended PCM latent hyperspace 130 operates through a two-level geometric architecture where multi-modal sensor data is initially embedded into a high-dimensional ambient space that provides sufficient degrees of freedom for representing complex cross-modal relationships. In some embodiments, this latent hyperspace may comprise 512 to 2048 dimensions, enabling rich encoding of heterogeneous sensor modalities including distributed acoustic sensing arrays, vibration sensor networks, and video surveillance streams along with their temporal and spatial contextual information. Within this high-dimensional hyperspace, the enhanced cognitive dynamics engine 140 discovers and maintains a lower-dimensional manifold, typically ranging from 32 to 128 dimensions, where semantic relationships between sensor modalities are preserved through geometric properties such as distance and curvature. The manifold represents a learned subspace within the hyperspace where effective sensor fusion patterns concentrate, with the surrounding hyperspace dimensions providing the geometric flexibility necessary for manifold evolution, topology changes, and adaptive cross-modal binding as new sensor patterns are encountered. This hierarchical structure enables the system to maintain computational efficiency through manifold-based operations while preserving the representational capacity of the full hyperspace for encoding novel multi-modal relationships and supporting continuous learning from infrastructure monitoring data.

An enhanced cognitive dynamics engine 140 governs the evolution of the latent manifold and supports reasoning across its structure. In some embodiments, a geometry manager maintains continuity of the manifold under ongoing updates, while preserving the metric constraints necessary for temporal coherence. Multi-scale zoom controllers may allow for seamless traversal across spatial and temporal scales, enabling users or autonomous agents to investigate patterns ranging from network-wide anomalies to localized component behavior. A fusion trajectory solver may compute geodesic reasoning paths through multi-modal regions, and an anomaly detection processor may identify deviations from expected geometric patterns based on, for example, localized curvature shifts or compression pressure differentials. In some implementations, a counterfactual simulation engine perturbs stored trajectories to explore alternative threat scenarios or support forensic reconstruction.

A secure multi-modal processing layer 150 enables privacy-preserving computation over sensor data while retaining geometric fidelity. For example, a homomorphic fusion processor may be employed to perform geometric transformations or threat analysis on encrypted data. In certain embodiments, correlation-based enhancement engines are configured to restore degraded signals using learned spatiotemporal priors derived from multiple modalities. Compression pressure metrics may be used by bandwidth optimization controllers to allocate resources adaptively based on the threat level or operational context. Privacy-preserving transmission mechanisms may retain manifold structure even under encryption, and federated learning coordinators may support inter-site knowledge sharing while maintaining local privacy and temporal ordering.

A fusion analysis and decision engine 160 extracts actionable intelligence from the latent manifold. In various embodiments, threat pattern recognition components identify correlated sensor events that signify potential threats, verifying these patterns against causality constraints to reduce false positives. The engine may further include classification modules that distinguish between types of events based on cross-modal signatures, and predictive analytics modules that extrapolate likely future developments from observed geodesic trajectories. Risk assessment operations may utilize manifold distance and curvature-based saliency to prioritize response actions. For example, confidence estimation engines may evaluate the reliability of conclusions based on the smoothness or stability of computed geodesic paths.

An output and response interface 170 presents results and enables human-system interaction. Real-time alert generators may notify operators of detected anomalies, while interactive visualization dashboards may display geodesic trajectories, compression pressure maps, and semantic overlays within the latent manifold. Operators may interact with threat models through zoomable interfaces that allow traversal across temporal and spatial dimensions. Forensic tools may reconstruct causal sequences from latent trajectory data, while scenario simulation tools may generate alternate projections for planning or training purposes.

A multi-scale cognitive navigation engine 180 facilitates operator engagement across levels of abstraction. In some embodiments, spatial zoom controllers allow users to transition from system-wide monitoring to localized analysis of individual sensor nodes. Temporal zoom controllers may support exploration of real-time, historical, or forecasted data intervals. The navigation engine may also coordinate changes across multiple dimensions (for example, spatial, temporal, and/or semantic) during an investigation. Visual overlays, for example, may highlight areas of high compression pressure or event saliency to guide attention, and causal flow visualizations may depict the evolution of events across sensor modalities within the manifold. Multi-modal input data 101 flows from the multi-modal sensor input layer 110 to the encoding engine 120, where it is temporally synchronized and embedded into geometric structures. These representations are passed into the extended PCM latent hyperspace 130 for persistent storage and reasoning. The cognitive dynamics engine 140 and secure processing layer 150 interact with the latent hyperspace to maintain structure, perform privacy-preserving computation, and apply reasoning algorithms. The results are interpreted by the fusion analysis and decision engine 160, which forwards insights to the output and navigation interfaces 170 and 180 for user interaction 102 and response coordination 103 In some embodiments, feedback from operators may influence subsequent processing by modifying the structure of the latent manifold within subsystem 130 or by adjusting attention vector priorities within the enhanced cognitive dynamics engine 140, based on new observations or system performance. In some embodiments, cognitive feedback mechanisms enable dynamic adaptation of the system by allowing operator input from the output and navigation interfaces to influence attention distribution within the cognitive dynamics engine, while decision outcomes from the fusion analysis engine may modify persistent representations in the latent manifold or adjust future reasoning strategies. Additionally, secure processing constraints may inform adaptive reasoning behavior, ensuring that geodesic computations remain robust under encrypted or bandwidth-limited conditions.

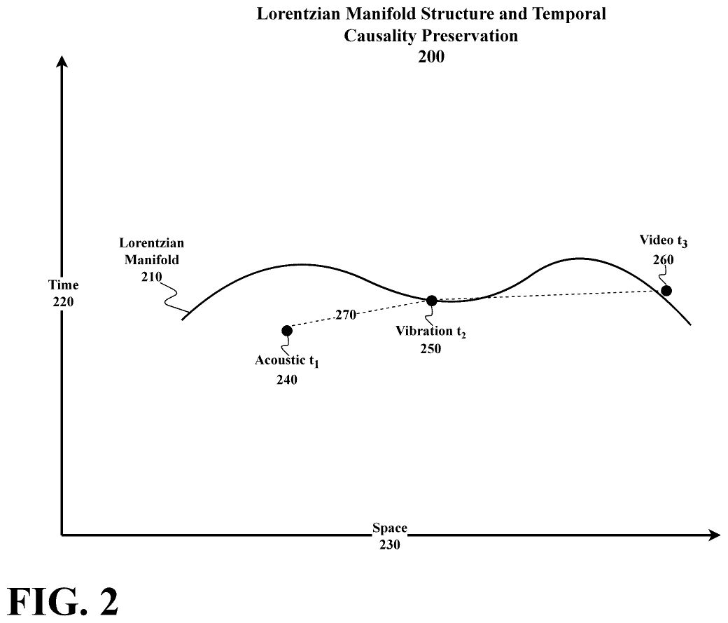

FIG. 2 is a diagram illustrating a Lorentzian manifold structure and temporal causality preservation in a multi-modal sensor fusion system 200, in an embodiment. In some embodiments, the embedding of sensor events into the Lorentzian manifold and the enforcement of temporal causality constraints are performed by the multi-modal encoding engine 120 in conjunction with the extended PCM latent hyperspace 130. Geodesic path computation and causality-aware reasoning are managed by the enhanced cognitive dynamics engine 140, which interprets the latent geometric structures to derive cross-modal inferences.

A Lorentzian manifold 210 is depicted as a curved geometric substrate that supports embedding of sensor data in a way that reflects both spatial distribution and temporal sequencing. The manifold structure is governed by a pseudo-Riemannian metric having a Lorentzian signature, such as (−, +, +, +), where one dimension is designated as time-like and others as space-like. This metric structure ensures that geometric computations maintain the causal ordering of events, preventing violations of time-forward progression during reasoning operations.

A time axis 220 represents the time-like coordinate, enabling the manifold to encode temporal relationships between sensor events. A space axis 230 represents the space-like dimensions used for spatial embedding of sensor data. The combined metric signature allows for geodesic path computation in a way that distinguishes between temporal and spatial contributions to event progression.

For example, an acoustic sensor event 240 may be embedded at a first time coordinate t₁, followed by a vibration sensor event 250 at time t₂, and a video sensor event 260 at time t₃. These events correspond to a typical physical sequence: an initial acoustic disturbance detected by a distributed acoustic sensing system, followed by corresponding vibrations measured by accelerometers or seismometers, and finally visual confirmation recorded by a video surveillance system.

A causal geodesic path 270 connects these events within Lorentzian manifold 210. The path represents an optimal trajectory through the latent space that respects the physical progression of events, maintaining the temporal ordering t₁<t₂<t₃. The manifold's metric structure enforces constraints on geodesic computation such that time-forward ordering is preserved, allowing the system to distinguish between plausible event sequences and coincidental sensor activations that lack causal coherence.

In operation, multi-modal sensor data is encoded into geometric representations placed within Lorentzian manifold 210 based on their spatial and temporal features. Cross-modal reasoning functions compute geodesic paths between events of interest, with each path evaluated against causality constraints defined by the underlying manifold geometry. This approach enables accurate correlation of sensor inputs by preserving the inherent timing relationships between phenomena, improving the system's ability to detect emerging threats, suppress false positives, and reconstruct causal chains for forensic analysis.

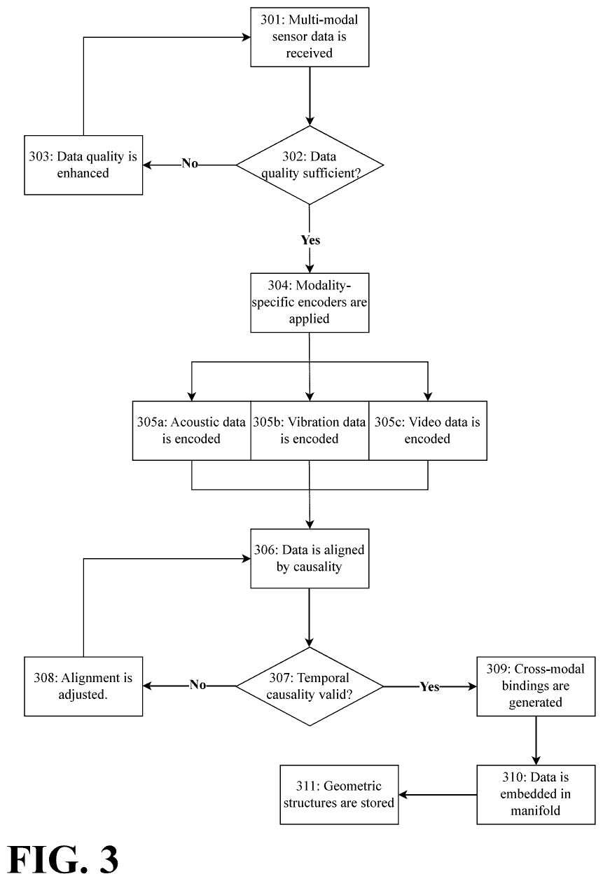

FIG. 3 is a flow diagram illustrating the multi-modal data encoding and geometric transformation process of geometric multi-modal fusion system 100, in an embodiment. The process begins when the multi-modal encoding engine 120 receives heterogeneous sensor data streams from distributed acoustic sensing arrays, vibration sensor networks, and video surveillance systems monitoring critical infrastructure environments 301. Upon receipt of the sensor data, the system performs an initial data quality assessment to determine whether the incoming signals have sufficient fidelity and completeness for geometric transformation, evaluating factors such as signal-to-noise ratios, temporal coverage, and spatial distribution across the monitored infrastructure 302.

When the data quality assessment determines that enhancement is required, correlation-based enhancement engines are activated to restore degraded signals using learned spatiotemporal priors from multiple sensor modalities 303. In some embodiments, this restoration process uses cross-modal dependencies to reconstruct missing or corrupted information while preserving the physical relationships between different sensor types. The enhanced data is then returned to the initial reception stage to ensure that all subsequent processing operates on sensor streams of adequate quality.

Once data quality validation is satisfied, modality-specific encoders are applied to transform each sensor type using specialized algorithms optimized for the unique characteristics of the corresponding data stream 304. For example, distributed acoustic sensing data is encoded through spectral analysis techniques that extract frequency-domain features while maintaining spatial context 305a. Vibration sensor data is encoded using time-series methods that detect mechanical resonance patterns, structural oscillations, and other temporal signatures indicative of equipment status or infrastructure anomalies 305b. Video surveillance streams are encoded using computer vision techniques that detect motion, identify objects, and extract relevant visual features such as trajectory vectors or scene transitions, while preserving frame-to-frame temporal continuity 305c.

The system then performs temporal synchronization by applying causal ordering constraints derived from the pseudo-Riemannian metric structure, aligning the encoded sensor data streams according to their natural physical sequence 306. In some embodiments, this alignment ensures that acoustic disturbances detected by fiber-optic arrays are followed by corresponding vibrations and visual confirmations, reflecting the expected order of events in infrastructure systems. After alignment, temporal causality validation is performed to verify that the time-ordered sequence conforms to physically plausible cause-and-effect progressions across modalities 307.

If causality validation fails, timing offsets between modalities are recalibrated to correct for inconsistencies, accounting for factors such as propagation delays, asynchronous sampling intervals, processing latencies, and sensor placement geometry 308. The recalibrated data is then resubmitted for causality validation to confirm that the revised alignment accurately reflects the temporal structure of real-world phenomena.

Once validated, cross-modal bindings are generated by creating association markers that link related acoustic, vibrational, and visual phenomena that arise from the same underlying physical event 309. These bindings establish coherent cross-modal groupings that serve as the basis for geometric embedding. The system then performs a Lorentzian geometric transformation, embedding the synchronized and causally validated sensor data into a latent manifold governed by a pseudo-Riemannian metric 310. This metric structure, which distinguishes temporal and spatial directions, preserves causality while enabling geodesic path computation and multi-modal reasoning.

Finally, the transformed sensor data is stored as geometric structures within the extended PCM latent hyperspace 130, organized into thought bundles that represent semantically related sensor fusion patterns 311. These persistent representations retain the temporal and cross-modal relationships established during the encoding process and serve as a substrate for the enhanced cognitive dynamics engine 140 to perform anomaly detection, threat correlation, and predictive analysis through manifold-based reasoning operations.

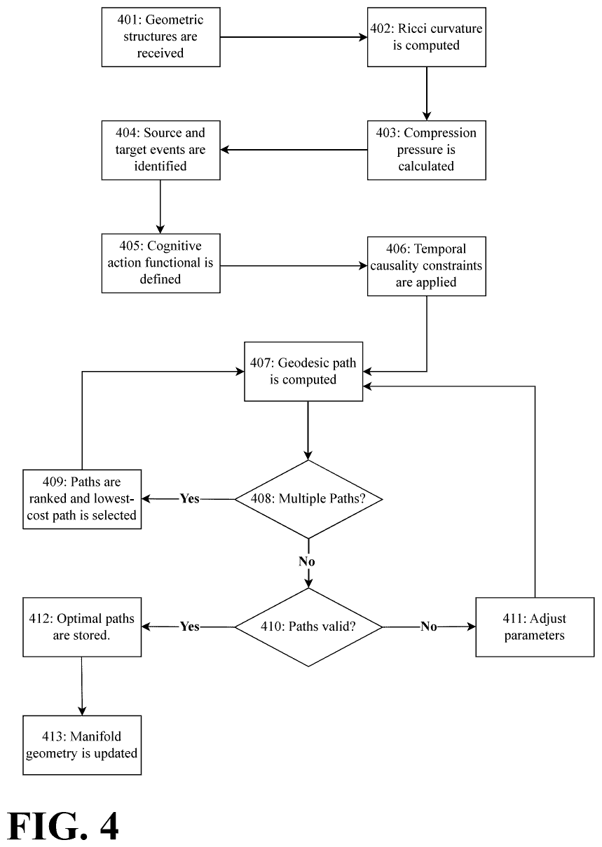

FIG. 4 is a flow diagram illustrating the compression pressure and geodesic path computation process performed by the enhanced cognitive dynamics engine 140, in an embodiment. The process begins when encoded geometric structures embedded in the PCM latent manifold 130 are received 401. These structures represent spatiotemporally distributed sensor events from distributed acoustic sensing arrays, vibration sensor networks, and video surveillance systems.

Ricci curvature is computed at each point in the latent manifold to determine local geometric properties that reflect information density and semantic clustering 402. Compression pressure is then calculated using the relationship P(x)=−R(x)P(x)=−R(x)P(x)=−R(x), where negative Ricci curvature yields pressure fields that indicate the cognitive cost of traversing semantically dense regions 403.

The system identifies source and target events that require cross-modal reasoning, such as acoustic disturbances, corresponding vibrations, and visual confirmations 404. A cognitive action functional S[γ]S[\gamma]S[γ] is defined to represent the total cost of traversing a given path. This includes kinetic energy, compression pressure penalties, and goal potential fields that guide attention toward relevant areas of the manifold 405.

Temporal causality constraints, derived from the pseudo-Riemannian metric, are applied to ensure time-forward progression through the manifold 406. The system solves the geodesic equation by minimizing the cognitive action functional subject to these constraints, producing optimal reasoning paths γ*(t)\gamma\hat{ }*(t)γ*(t) that preserve causal relationships across sensor modalities 407.

If multiple geodesics connect the same source and target, they are ranked by total action cost. The lowest-cost path is selected as the primary reasoning trajectory, while alternatives may be retained for counterfactual simulation or backup reasoning 409. Each computed geodesic is validated to confirm that it maintains time-like characteristics and respects causal event ordering 410. If validation fails, goal potential fields or constraint weights are adjusted to discover an alternative, physically plausible trajectory 411. Once validated, the optimal path and its associated action cost are stored in the latent manifold as a persistent geometric structure γ*(t)\gamma\hat{ }*(t)γ*(t), supporting future cross-modal reasoning and efficient retrieval of known reasoning sequences 412. The system then updates the local geometry of the manifold by reinforcing regions that contributed to successful reasoning, modifying curvature and strengthening connections along effective geodesic paths 413.

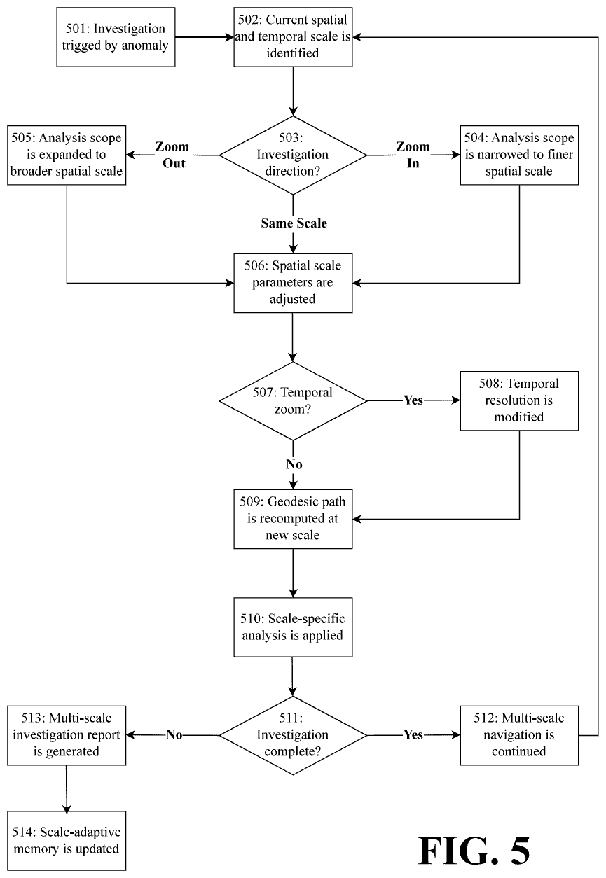

FIG. 5 is a flow diagram illustrating the multi-scale investigation and zoom capabilities of the multi-scale cognitive navigation engine 180, in an embodiment. In some embodiments, this multi-scale investigation process is implemented by the multi-scale cognitive navigation engine 180 in coordination with the extended PCM latent hyperspace 130 and enhanced cognitive dynamics engine 140.

The process begins when an anomaly or significant event is detected at the current analysis scale through geodesic pattern analysis within the PCM latent manifold, triggering an investigation workflow that enables operators to traverse across spatial and temporal resolution levels to understand the context and implications of the detected phenomenon 501.

Upon event detection, the system identifies the current analysis scale, including both the spatial resolution level—such as network-wide monitoring, facility-level analysis, or individual component diagnostics—and the temporal scope, which may include real-time evaluation, historical review, or predictive forecasting based on stored trajectory patterns 502.

The investigation direction is then evaluated. Operators are presented with options to zoom in for increased resolution detail, zoom out for broader context, or remain at the current scale for continued analysis 503. When a zoom-in operation is selected, the system transitions, for example, from network-level analysis to facility-specific investigation, or from facility-level down to individual component behavior 504. If zooming out is required, the system shifts from component-level analysis to broader facility-wide trends, or from localized events to network-wide infrastructure patterns 505.

Once the spatial zoom direction is selected, the system adjusts geometric scale parameters within the latent manifold. This may include modifying compression pressure sensitivity to match resolution needs, rescaling the coordinate system, and updating the resolution of attention vector fields to guide cognitive focus appropriately 506.

The system then evaluates whether a temporal zoom adjustment is also warranted based on the scope of the investigation 507. When a temporal scale shift is required, the system modifies the time resolution using Lorentzian time dilation techniques. This enables operators to slow down the playback of fast-developing events for detailed examination or accelerate review of long time windows to identify emergent patterns more efficiently 508.

Following scale adjustment, geodesic paths are recomputed using scale-adaptive memory access. In some embodiments, this involves retrieving stored patterns and behavioral trajectories that are most relevant to the current resolution level, ensuring that path computation remains context-appropriate 509.

Next, the system applies scale-specific analysis techniques based on the selected resolution. Network-level reasoning may include infrastructure-wide pattern recognition and correlation analysis, while facility-level analysis focuses on system interactions and interdependencies. At the component level, the system may perform sensor-specific diagnostics and fault localization 510.

Once analysis is complete, the system evaluates whether investigation objectives have been satisfied or if additional resolution changes are needed to complete the assessment 511. If multi-scale traversal is still required, the system enables continued navigation across spatial and temporal levels as the investigation evolves or as new insights emerge 512.

When the investigation is complete, the system generates a comprehensive multi-scale report. This report integrates findings across all scales, presenting network context, facility insights, and component-level diagnostics within a unified event timeline that preserves causal relationships 513. Finally, the system updates its scale-adaptive memory by storing successful investigation paths and reinforcing effective navigation strategies for use in future investigations 514.

In some embodiments, this multi-scale investigation process is implemented by the multi-scale cognitive navigation engine 180 in coordination with the extended PCM latent hyperspace 130 and enhanced cognitive dynamics engine 140.

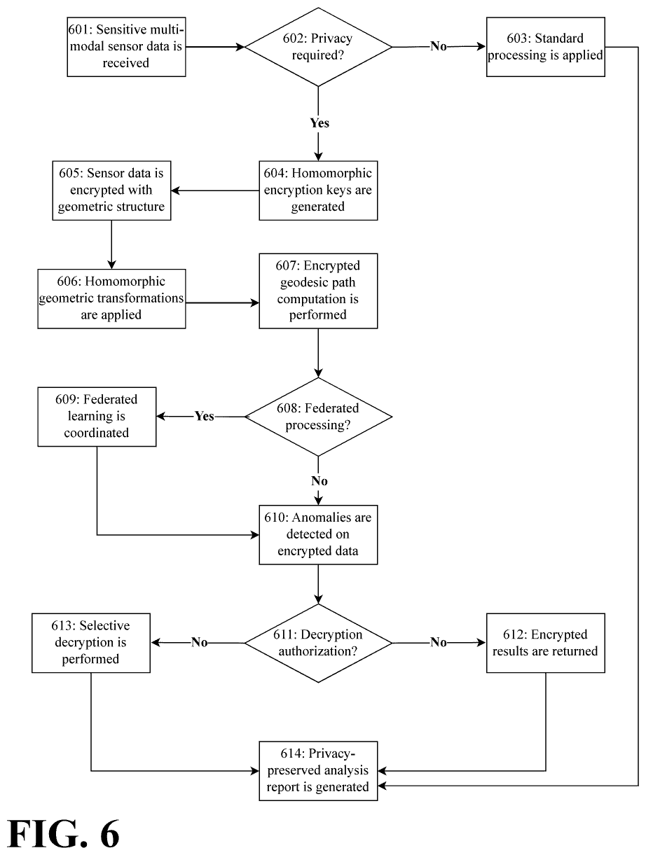

FIG. 6 is a flow diagram illustrating the homomorphic processing and privacy preservation capabilities of the secure multi-modal processing layer 150, in an embodiment. In some embodiments, this process is performed by the secure multi-modal processing layer 150 in coordination with the enhanced cognitive dynamics engine 140 and the extended PCM latent hyperspace 130.

The process begins when sensitive multi-modal sensor data is received from critical infrastructure monitoring systems, including distributed acoustic sensing arrays, vibration sensor networks, and video surveillance systems that capture operationally sensitive information requiring protection during analysis operations 601.

The system evaluates whether privacy-preserving computation is required based on data classification policies, regulatory mandates, or operational security constraints governing the handling of infrastructure monitoring data 602. When privacy protection is not required, the system proceeds with standard geometric processing, applying manifold embedding, geodesic path computation, and anomaly detection without encryption overhead 603.

If privacy preservation is required, the system generates homomorphic encryption keys by creating a public-private key pair that supports encrypted computation while preserving necessary mathematical relationships for latent manifold operations 604. The sensor data is then encrypted using homomorphic techniques that maintain geometric structure under encryption, ensuring compatibility with downstream manifold embedding and temporal-spatial relationships 605.

Homomorphic geometric transformations are applied to the encrypted data, enabling manifold computations such as geodesic trajectory solving, compression pressure evaluation, and attention vector flow without decryption 606. Encrypted reasoning operations are then performed by the enhanced cognitive dynamics engine, which computes geodesic paths between encrypted sensor events while preserving causal structure and cross-modal alignment 607.

The system then evaluates whether federated processing is required to support distributed reasoning across infrastructure sites or organizational boundaries 608. If federated processing is required, the system coordinates federated learning operations using encrypted model updates. These updates enable collaborative learning while preserving local privacy and temporal causality across distributed cognitive nodes 609.

Anomaly detection is then performed directly on the encrypted geometric data using privacy-preserving analysis algorithms. These algorithms compute threat scores and identify deviations without exposing underlying sensor values or spatial positions 610.

Following analysis, the system evaluates whether decryption authorization has been granted for the computed results 611. If authorization is denied, encrypted threat assessments and anomaly scores are returned, allowing only authorized personnel with decryption keys to access the results 612. If decryption is authorized, the system performs selective decryption that reveals approved result components, such as anomaly classifications or threat severity levels, while retaining encryption of sensitive raw data and intermediate computations 613.

A privacy-preserved analysis report is then generated, containing actionable intelligence derived from encrypted reasoning while maintaining confidentiality of the underlying sensor data 614.

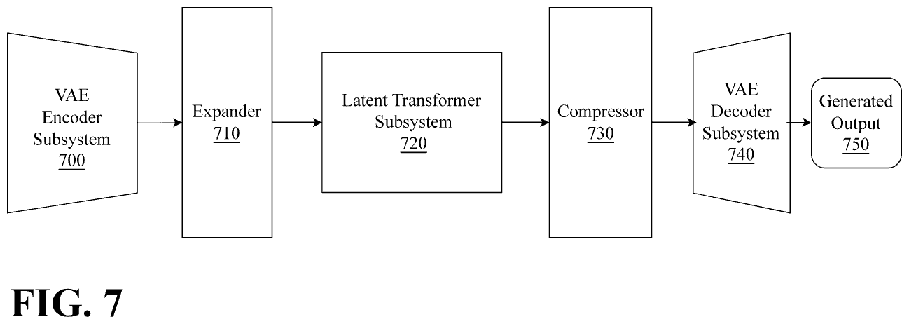

FIG. 7 s a block diagram illustrating an exemplary latent transformer architecture including a VAE encoder, latent transformer, and decoder subsystem, which may be used in some embodiments to implement latent space processing within system 100. Central to a latent transformer is a latent transformer subsystem 720, which serves as the central processing unit responsible for learning the underlying patterns, relationships, and dependencies within the input data. Latent transformer subsystem 720 leverages advanced techniques such as self-attention mechanisms and multi-head attention to capture the complex interactions and sequences in the data, enabling it to generate accurate and context-aware outputs.

The input to latent transformer subsystem 720 is provided by a VAE (Variational Autoencoder) encoder subsystem 700. VAE encoder subsystem 700 is responsible for encoding an input into a lower-dimensional latent space representation. VAE encoder subsystem 700, learns to compress the data into a compact latent space representation while preserving the essential features and characteristics of the input. Latent space vectors produced by the VAE encoder subsystem 700 may be further processed by an expander 710, which increases the dimensionality of the input data to a point where the vectors can be efficiently processed by latent transformer subsystem 720.

A latent space representation of the input generated by VAE encoder subsystem 700 serves as the input to latent transformer subsystem 720. Latent transformer subsystem 720 operates in this latent space, leveraging the compressed and informative representation to learn the complex patterns and relationships within the data. By working in the latent space, latent transformer subsystem 720 can efficiently process and model the data, capturing the intricate dependencies and generating accurate and meaningful outputs.

Once latent transformer subsystem 720 has processed the latent space representation, the generated output is passed through a VAE decoder subsystem 740. VAE decoder subsystem 740 is responsible for decoding the latent space representation back into the original data space. Prior to processing by VAE decoder subsystem 740, latent transformer subsystem 720 outputs may be compressed back to an original size before being processed by the expander 710 by being processed by a compressor 730. VAE decoder subsystem 740 learns to reconstruct the original data from the latent space representation, ensuring that the generated output is coherent and meaningful.

The reconstructed output from VAE decoder subsystem 740 is provided as a compressed generated output 750. The compressed generated output 750 represents the final result of the latent transformer, which is a compressed version of the original input.

VAE encoder subsystem 700 and VAE decoder subsystem 740 play large roles in the overall functioning of the latent transformer. VAE encoder subsystem 700 enables the system to learn a compressed and informative representation of the input data in the latent space, while the VAE decoder subsystem 740 ensures that the compressed generated output 750 is coherent and meaningful by reconstructing it back into the original data space. The combination of these subsystems allows the latent transformer to focus on learning the complex patterns and relationships within the data, leading to accurate and context-aware outputs.

The specific architectures and parameters of VAE encoder subsystem 700, latent transformer subsystem 720, and VAE decoder subsystem 740 can be customized and adapted based on the characteristics and requirements of the input data and the specific task at hand. The modular design of the system allows for flexibility and extensibility, enabling the integration of different architectures, attention mechanisms, and training techniques to optimize the performance and efficiency of the latent transformer.

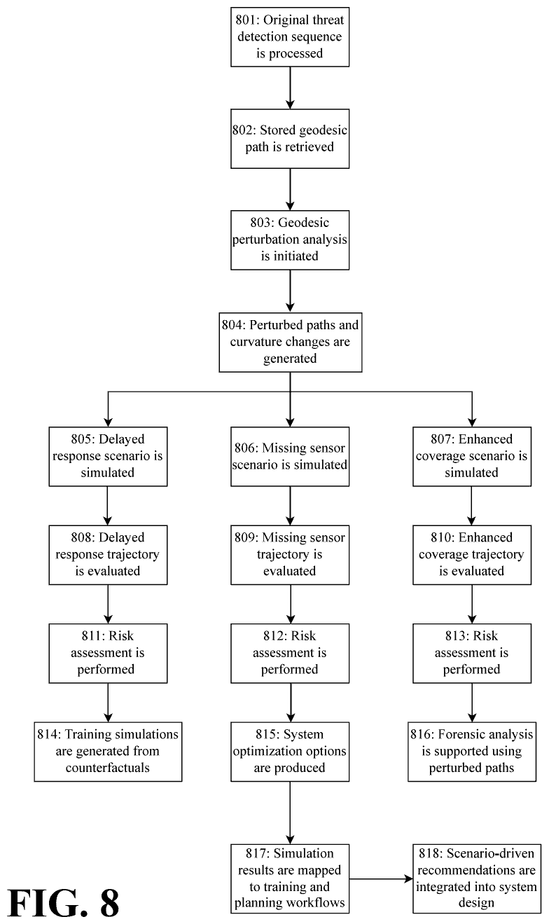

FIG. 8 is a flow diagram illustrating counterfactual simulation and scenario generation within geometric multi-modal fusion system 100, in an embodiment. In some embodiments, this simulation process is performed by the enhanced cognitive dynamics engine 140 in coordination with the extended PCM latent hyperspace 130 and the fusion analysis engine 160.

The process begins when an original threat event is detected and processed, creating a baseline geodesic path in the PCM latent hyperspace. This baseline path reflects a typical sequence in which acoustic sensors detect an initial disturbance, followed by vibration measurements and visual confirmation, with each modality embedded at distinct time coordinates preserving causal ordering 801.

The enhanced cognitive dynamics engine 140 retrieves the stored optimal geodesic path γ*\gamma\hat{ }*, representing the multi-modal detection sequence. This path exists as a persistent geometric structure in latent hyperspace 130, encoding both the sensor sequence and the reasoning trajectory that respects pseudo-Riemannian metric constraints 802.

A counterfactual simulation engine initiates geodesic perturbation analysis by applying controlled modifications to γ*\gamma\hat{ }*. These perturbations explore variations in event timing, sensor configuration, or system state while preserving manifold coherence 803. Perturbation vectors, alternative paths, and updated curvature fields are generated to model how changes in data or configuration would affect compression pressure and geometric reasoning 804.

Three illustrative counterfactual scenarios are created. In the first, a 30-second delay in initial detection is modeled, simulating the effects of network latency or operator delay on geodesic structure and system response 805. In the second, vibration sensor input is removed to simulate failure, and the system evaluates how reasoning adapts using only acoustic and visual modalities 806. In the third, additional cameras are introduced, testing how improved visual coverage modifies the path and affects detection timing and confidence 807.

Each scenario produces a distinct trajectory branch through the manifold. The delayed response branch shows higher threat escalation and elevated compression pressure in critical regions 808. The missing sensor branch shows adaptive behavior with reduced confidence due to lost cross-modal support 809. The enhanced camera scenario results in earlier detection and improved manifold alignment for faster response 810.

The system conducts quantitative risk assessments for each scenario. This includes probability estimates derived from historical patterns and manifold structure, impact scores based on compression pressure and geodesic deformation, and response recommendations optimized for the perturbed configurations 811-813. For example, the delayed response scenario may yield a high-impact, moderate-probability outcome with recommendations for backup sensors, while the enhanced camera case may yield a low-risk, high-probability benefit.

The results support multiple operational applications. Training simulations use these variations to prepare operators with realistic event sequences reflecting detection timing, sensor failure, or system upgrades 814. Optimization processes apply the counterfactual analysis to support infrastructure design, sensor placement, and communication network planning 815. Forensic analysis applications use the perturbation engine to reconstruct alternative timelines and assess hypothetical system configurations post-incident 816.

Each application relies on the counterfactual simulation engine's ability to produce structured, realistic variation patterns. Training systems use risk scores to define scenario difficulty. Optimization workflows use geodesic outputs and compression pressure shifts to evaluate return-on-investment for system enhancements 817. Forensic tools leverage the perturbed paths to understand causal mechanisms behind observed system behaviors and evaluate hypothetical mitigation strategies 818.

### Hardware Architecture

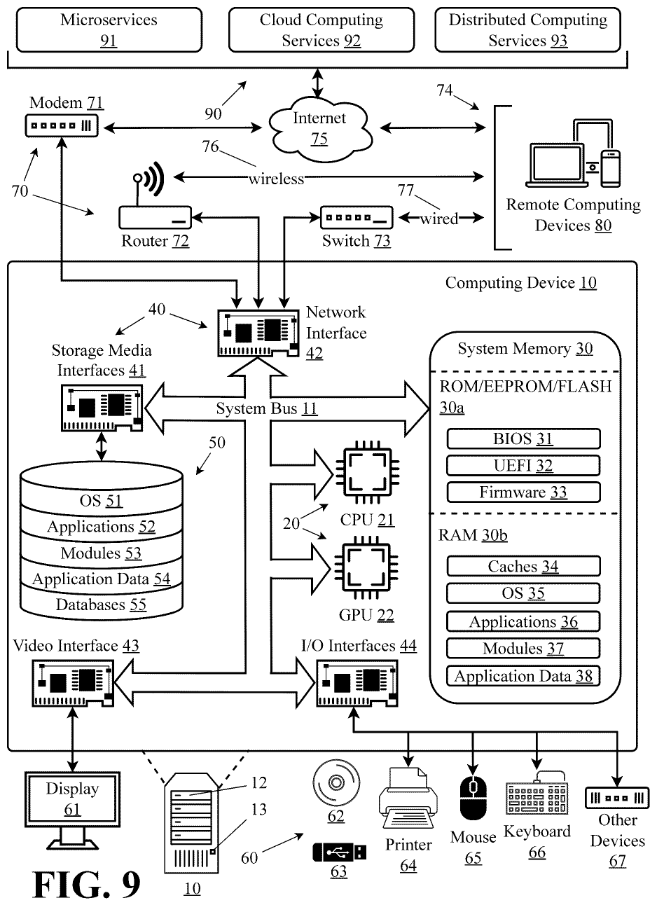

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Container provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Federated distributed computing services 93 provide large-scale processing using multiple interconnected computers or nodes to solve computational problems or perform tasks collectively. In federated distributed computing, the processing and storage capabilities of multiple machines are leveraged to work together as a unified system, even when different tiers or tessellations may have limited or even no visibility into the resources and processing layer up or downstream. Federated distributed computing services are designed to address problems that cannot be efficiently solved by a single computer or that require large-scale computational power and require dynamism and workload distribution for economic, security or privacy reasons not well supported by canonical distributed computing resources; e.g. most commonly cloud-based computing applications, resources or analytics. Federated DCG coordinated variants of these services enable superior decentralization and further enhance parallel processing, fault tolerance, and scalability by distributing tasks across multiple tiers or tessellations while enabling computing process dependency calculation with varying degrees of visibility, assurance and privacy or security based on constituent computing system, network, workload and user or provider needs and preferences as well as practical legal and regulatory concerns to include but not limited to data localization, national data transfer restrictions, privacy and consumer protections, wiretap/telecommunications monitoring requirements, encryption and data routing and intermediate processing restrictions.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain a latent manifold as a geometric substrate for cognitive operations, wherein the latent manifold has a pseudo-Riemannian metric that distinguishes temporal and spatial directions to preserve causality, and wherein the latent manifold evolves through use;
receive multi-modal sensor data comprising heterogeneous sensor inputs from infrastructure monitoring systems;
encode the multi-modal sensor data into geometric structures within the latent manifold, wherein semantic relationships between sensor modalities are represented through geometric properties including distance and curvature;
compress the multi-modal sensor data using compression methods that preserve geometric relationships;
compute geodesic paths through the latent manifold for cross-modal reasoning, wherein the paths connect related phenomena across different sensor modalities and are influenced by compression pressure derived from manifold curvature;
store persistent multi-modal representations as geometric regions within the latent manifold, wherein frequently accessed sensor fusion patterns develop characteristic geometric properties;
detect anomalies by identifying deviations from normal geometric patterns through compression pressure analysis and cross-modal geodesic correlation;
modify the geometric structure of the latent manifold based on cognitive operations, wherein successful detection patterns create persistent modifications to the manifold geometry; and
generate outputs by traversing the latent manifold and decoding geometric information into user-interpretable responses.

2. The computer system of claim 1, wherein the pseudo-Riemannian metric constrains geodesic paths to preserve temporal causality by maintaining time-forward progression through the manifold.

3. The computer system of claim 1, wherein the multi-modal sensor data comprises distributed acoustic sensing data, vibration sensor data, and video surveillance data from critical infrastructure monitoring.

4. The computer system of claim 1, wherein computing geodesic paths comprises calculating trajectories that maintain causal ordering of sensor events across different modalities.

5. The computer system of claim 1, wherein the software instructions further cause the computer system to perform multi-scale navigation by continuously traversing the latent manifold across different levels of spatial and temporal resolution.

6. The computer system of claim 1, wherein detecting anomalies comprises identifying regions of high compression pressure that exceed predetermined thresholds indicating areas requiring detailed analysis.

7. The computer system of claim 1, wherein the software instructions further cause the computer system to generate alternative scenarios by modifying stored geodesic paths and computing resulting trajectory variations.

8. The computer system of claim 1, wherein the compression methods comprise homomorphic encryption that enables computation on encrypted sensor data while preserving the geometric relationships in the latent manifold.

9. The computer system of claim 1, wherein the software instructions further cause the computer system to enhance degraded sensor data using correlation-based reconstruction that leverages learned spatiotemporal patterns from multiple sensor modalities.

10. The computer system of claim 1, wherein the software instructions further cause the computer system to synchronize multi-modal sensor streams by aligning temporal sequences according to causal ordering constraints derived from the pseudo-Riemannian metric.

11. A computer-implemented method for multi-modal sensor fusion, comprising:
maintaining a latent manifold as a geometric substrate for cognitive operations, wherein the latent manifold has a pseudo-Riemannian metric that distinguishes temporal and spatial directions to preserve causality, and wherein the latent manifold evolves through use;
receiving multi-modal sensor data comprising heterogeneous sensor inputs from infrastructure monitoring systems; encoding the multi-modal sensor data into geometric structures within the latent manifold, wherein semantic relationships between sensor modalities are represented through geometric properties including distance and curvature;
compressing the multi-modal sensor data using compression methods that preserve geometric relationships;
computing geodesic paths through the latent manifold for cross-modal reasoning, wherein the paths connect related phenomena across different sensor modalities and are influenced by compression pressure derived from manifold curvature;
storing persistent multi-modal representations as geometric regions within the latent manifold, wherein frequently accessed sensor fusion patterns develop characteristic geometric properties;
detecting anomalies by identifying deviations from normal geometric patterns through compression pressure analysis and cross-modal geodesic correlation;
modifying the geometric structure of the latent manifold based on cognitive operations, wherein successful detection patterns create persistent modifications to the manifold geometry; and
generating outputs by traversing the latent manifold and decoding geometric information into user-interpretable responses.

12. The method of claim 11, wherein the pseudo-Riemannian metric constrains geodesic paths to preserve temporal causality by maintaining time-forward progression through the manifold.

13. The method of claim 11, wherein the multi-modal sensor data comprises distributed acoustic sensing data, vibration sensor data, and video surveillance data from critical infrastructure monitoring.

14. The method of claim 11, wherein computing geodesic paths comprises calculating trajectories that maintain causal ordering of sensor events across different modalities.

15. The method of claim 11, further comprising performing multi-scale navigation by continuously traversing the latent manifold across different levels of spatial and temporal resolution.

16. The method of claim 11, wherein detecting anomalies comprises identifying regions of high compression pressure that exceed predetermined thresholds indicating areas requiring detailed analysis.

17. The method of claim 11, further comprising generating alternative scenarios by modifying stored geodesic paths and computing resulting trajectory variations.

18. The method of claim 11, wherein the compression methods comprise homomorphic encryption that enables computation on encrypted sensor data while preserving the geometric relationships in the latent manifold.

19. The method of claim 11, further comprising enhancing degraded sensor data using correlation-based reconstruction that leverages learned spatiotemporal patterns from multiple sensor modalities.

20. The method of claim 11, further comprising synchronizing multi-modal sensor streams by aligning temporal sequences according to causal ordering constraints derived from the pseudo-Riemannian metric.
